(19) United States
(12) Patent Application Publication
(10) Pub. No.: US 2023/0169708 A1
(43) Pub. Date: Jun. 1, 2023

(54) IMAGE AND VIDEO MATTING

(71) Applicant: JJK Holdings, LLC., San Jose, CA (US)

(72) Inventors: Jason Yang, San Jose, CA (US); Luis David Lopez-Gutierrez, Albuquerque, NM (US)

(21) Appl. No.: 17/536,073

(22) Filed: Nov. 28, 2021

(51) Int. Cl. G06T 11/60; G06F 3/04842; G06F 3/04845; G06N 3/02

(52) U.S. Cl. CPC G06T 11/60; G06F 3/04842; G06F 3/04845; G06N 3/02

(57) ABSTRACT

A method of generating a matte for an image is disclosed. The method includes, with a processor, receiving image data representing the image, with the processor, selecting one or more objects represented in the image data, with the processor, generating an intermediate matte based on the selected objects, and with the processor, generating one or more splines based on the intermediate matte, where at least one of the selecting of the one or more objects, the generating of the intermediate matte, and the generating of the splines is performed by an artificial intelligence system. The method also includes, with the processor, receiving instructions to modify the generated splines, with the processor, generating modified splines by modifying the generated splines according to the received instructions, with the processor, generating training data based on the modified splines, and with the processor, training the artificial intelligence system with the training data.

### TECHNICAL FIELD

The subject matter described herein relates to image processing, and more particularly to image and video matting.

### BACKGROUND

Particular foreground objects within images may be extracted from the remainder of the image, for example, to place the object in a different image having a different background. An image matte may be used to extract a particular foreground object in the image.

Generating accurate mattes can be difficult, particularly if the foreground object has very fine features, such as hair, is transparent or translucent (e.g., glass or smoke), or if the foreground object is blurry.

### SUMMARY

One inventive aspect is a method of generating a matte for an image. The method includes, with a processor, receiving image data representing the image, with the processor, selecting one or more objects represented in the image data, with the processor, generating an intermediate matte based on the selected objects, and with the processor, generating one or more splines based on the intermediate matte, where at least one of the selecting of the one or more objects, the generating of the intermediate matte, and the generating of the splines is performed by an artificial intelligence system. The method also includes, with the processor, receiving instructions to modify the generated splines, with the processor, generating modified splines by modifying the generated splines according to the received instructions, with the processor, generating training data based on the modified splines, and with the processor, training the artificial intelligence system with the training data.

In some embodiments, the image is one of a series of video images.

In some embodiments, the one or more objects are selected based at least in part on one or more inputs from a user.

In some embodiments, the one or more objects are selected automatically by the processor.

In some embodiments, the intermediate matte is generated based at least in part on one or more inputs from a user.

In some embodiments, the intermediate matte is generated automatically by the processor.

In some embodiments, the one or more splines are generated based at least in part on one or more inputs from a user.

In some embodiments, the one or more splines are generated automatically by the processor.

In some embodiments, the one or more splines each include a plurality of control points, and the method further includes, with the processor, receiving data representing a reference image, and with the processor, modifying a position of a particular control point based on the reference image.

In some embodiments, the position of the particular control point is modified before the instructions to modify the generated splines are received.

In some embodiments, the position of the particular control point is additionally modified after the instructions to modify the generated splines are received.

Another inventive aspect is a method of generating a matte for each image of a series of video images. The method includes, with a processor, receiving data for a first image of the series of video images, with the processor, receiving data for a reference matte, with the processor, generating an intermediate matte based on the data for the first image and the data for the reference matte, with the processor, generating the intermediate matte, and, with the processor, generating one or more splines based on the intermediate matte, where at least one of the generating of the intermediate matte, and the generating of the one or more splines is performed by an artificial intelligence system. The method also includes, with the processor, receiving instructions to modify the generated splines, with the processor, generating modified splines by modifying the generated splines according to the received instructions, with the processor, generating training data based on the modified splines, and with the processor, training the artificial intelligence system with the training data.

In some embodiments, the method also includes, generating the data for the reference matte based on another intermediate matte generated for a second image of the series of video images.

In some embodiments, the intermediate matte is generated based at least in part on one or more inputs from a user.

In some embodiments, the intermediate matte is generated automatically by the processor.

In some embodiments, the one or more splines are generated based at least in part on one or more inputs from a user.

In some embodiments, the one or more splines are generated automatically by the processor.

In some embodiments, the one or more splines each include a plurality of control points, and the method further includes, with the processor, receiving data representing a reference image, and with the processor, modifying a position of a particular control point based on the reference image.

In some embodiments, the position of the particular control point is modified before the instructions to modify the generated splines are received.

In some embodiments, the position of the particular control point is additionally modified after the instructions to modify the generated splines are received.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations.

FIG. 1 illustrates a flowchart diagram representing features of a method of generating a matte for an image according to some embodiments.

FIG. 2 illustrates a flowchart diagram representing features of a method of selecting objects according to some embodiments.

FIG. 3 illustrates a flowchart diagram representing features of a method of segmenting an image according to some embodiments.

FIG. 4 illustrates a flowchart diagram representing features of a method of generating splines for a matte according to some embodiments.

FIG. 5 illustrates a flowchart diagram representing features of a method of tracking splines according to some embodiments.

FIG. 6 illustrates a flowchart diagram representing features of a method of generating a matte for an image according to some embodiments.

FIG. 7 illustrates a flowchart diagram representing features of a method of segmenting an image according to some embodiments.

FIG. 8 illustrates a flowchart diagram representing features of a method of segmenting an image according to some embodiments.

FIG. 9 illustrates a computer system which may be used to perform aspects of the methods according to some embodiments.

When practical, similar reference numbers denote similar structures, features, or elements.

### DETAILED DESCRIPTION

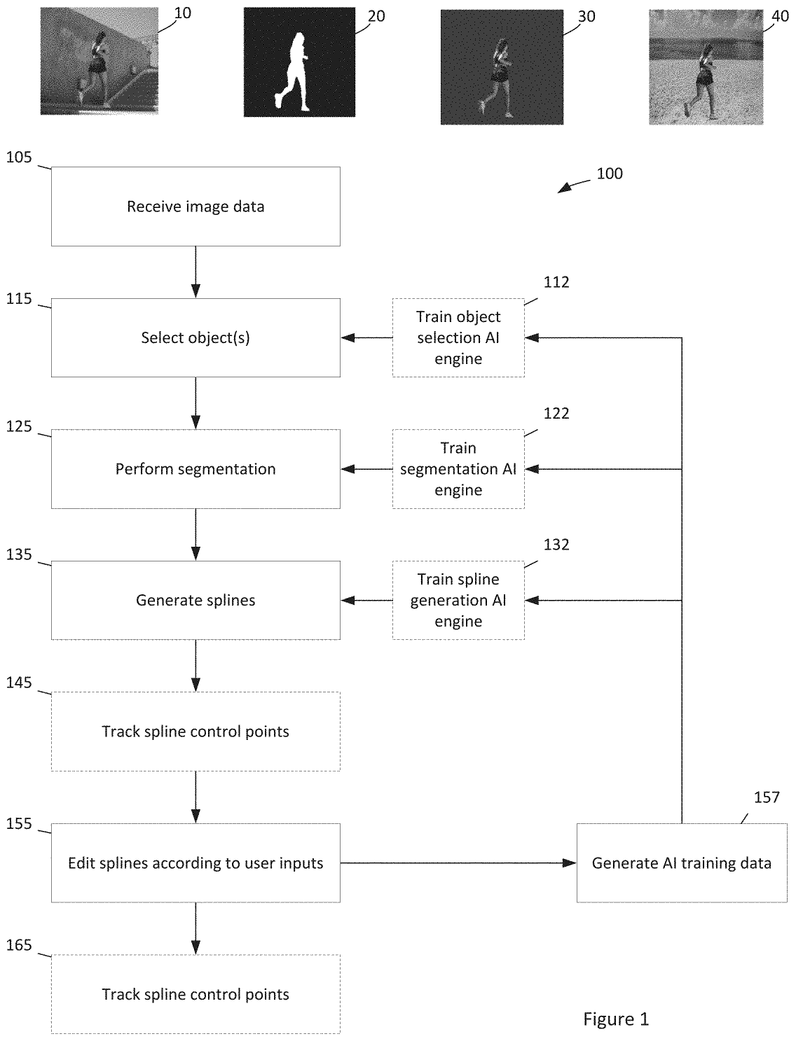

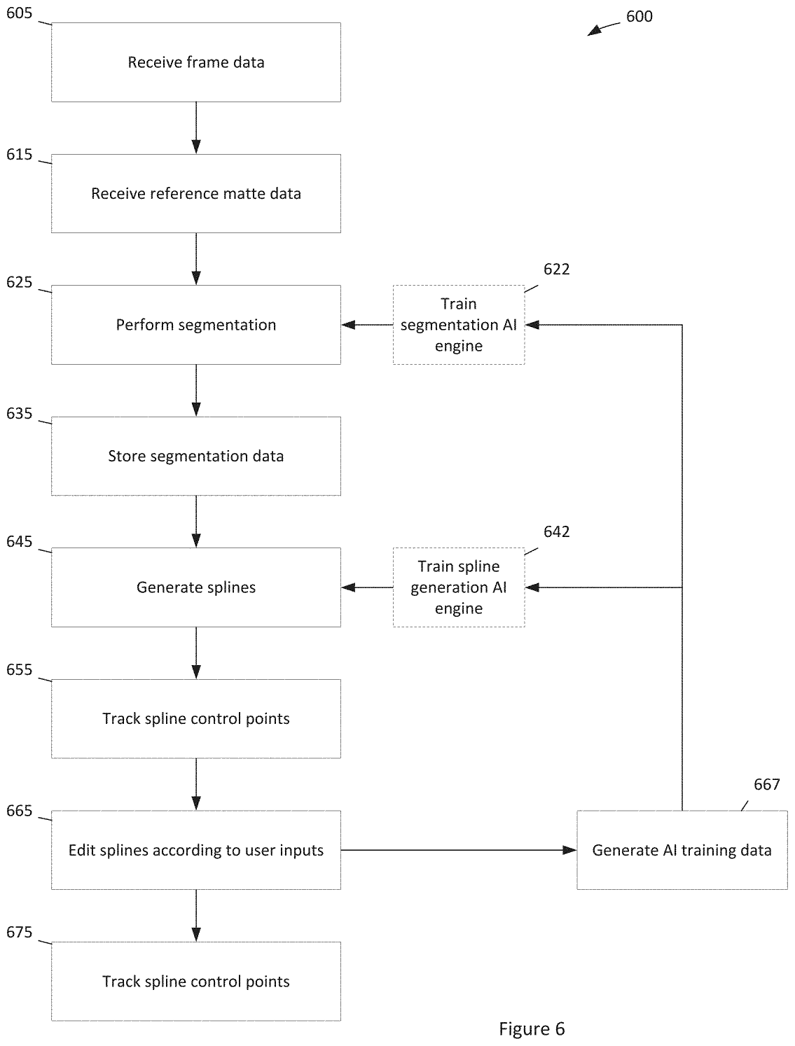

As discussed in further detail below, computer systems may be used to generate image mattes which may be used to separate objects or elements of interest from background elements. FIGS. 1-5 illustrate methods of generating mattes for single images, and which may use one or more artificial intelligence systems for generating one or more intermediate outputs. FIGS. 6-8 illustrate methods of generating mattes for frames of video, and which may use one or more artificial intelligence systems for generating one or more intermediate outputs.

Several illustrative embodiments will now be described with respect to the accompanying drawings, which form a part hereof. The ensuing description provides embodiment(s) only and is not intended to limit the scope, applicability, or configuration of the disclosure. Rather, the ensuing description of the embodiment(s) will provide those skilled in the art with an enabling description for implementing one or more embodiments. It is understood that various changes may be made in the function and arrangement of elements without departing from the spirit and scope of this disclosure. In the following description, for the purposes of explanation, specific details are set forth in order to provide a thorough understanding of certain inventive embodiments. However, it will be apparent that various embodiments may be practiced without these specific details. The figures and description are not intended to be restrictive. The word “example” or “exemplary” is used herein to mean “serving as an example, instance, or illustration.” Any embodiment or design described herein as “exemplary” or “example” is not necessarily to be construed as preferred or advantageous over other embodiments or designs.

Rotoscoping or matting or segmentation is or includes the process of creating a mask or matte that separates objects or elements of interest from the background. Separated elements can then be placed in other backgrounds or environments in the compositing process. The simplest way to achieve this effect is to film on top of a green screen (or other color) and “keying” or separating the green from the frame. Chroma keying is another term. However it's not always possible to use green screen or sometimes the green screen capture is imperfect. Then rotoscoping may be used to separate objects from the background.

In some embodiments discussed herein, artificial intelligence is used to perform the matting process to achieve a high degree of accurate processing and either completely eliminating or reducing artist involvement.

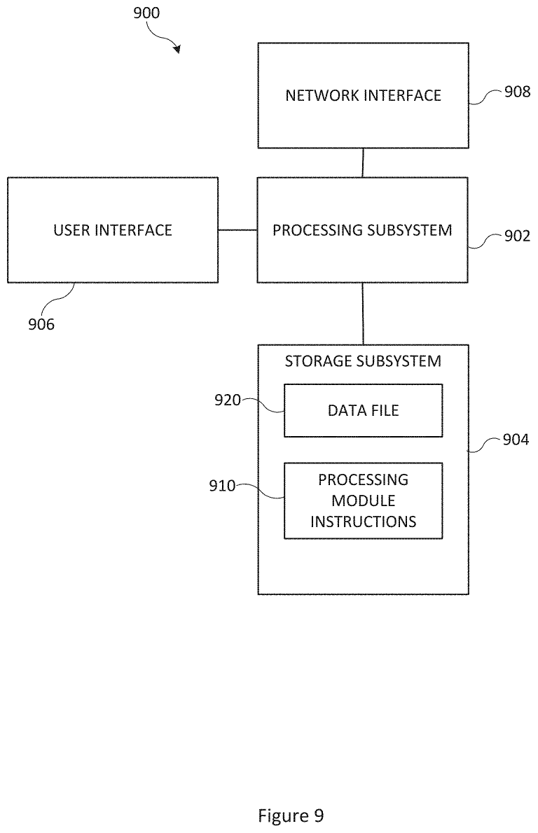

FIG. 1 illustrates a flowchart diagram representing features of a method 100 of generating a matte for an image according to some embodiments. The method may be performed using a computer system, such as that described with reference to FIG. 9. The method may alternatively be performed using different computer systems. In some embodiments, the method 100 is repeated for each of a series of images, where the series of images represent video.

At 105, data representing an image is received. For example, data representing the illustrated image 10 may be received, for example, at a processor. In some embodiments, the received data represents a color image.

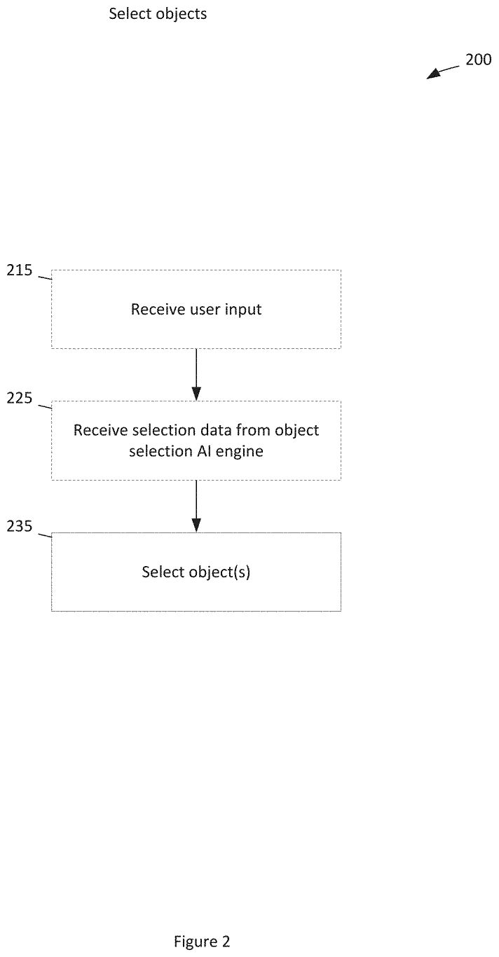

At 115, one or more objects represented in the image are selected, for example, by a computer system. The selection may be made in response to inputs provided by a user viewing a graphical interface displaying the image, where the inputs provide an indication of the object or objects to be selected. In some embodiments, the object or objects or parts thereof are selected automatically by the computer system. In some embodiments, one or more of the objects or parts thereof are selected automatically, and an additional one or more objects or parts thereof are selected in response to inputs provided by a user. In some embodiments, the automatic selection of one or more objects or parts thereof is performed using an object selection artificial intelligence system having object selection parameters which are modified based on differences between object boundaries determined by the object selection artificial intelligence system and object boundaries determined by a user for objects in images different from the image represented by the data received at 105. An embodiment of a method which can be used to select the objects is discussed below with reference to FIG. 2.

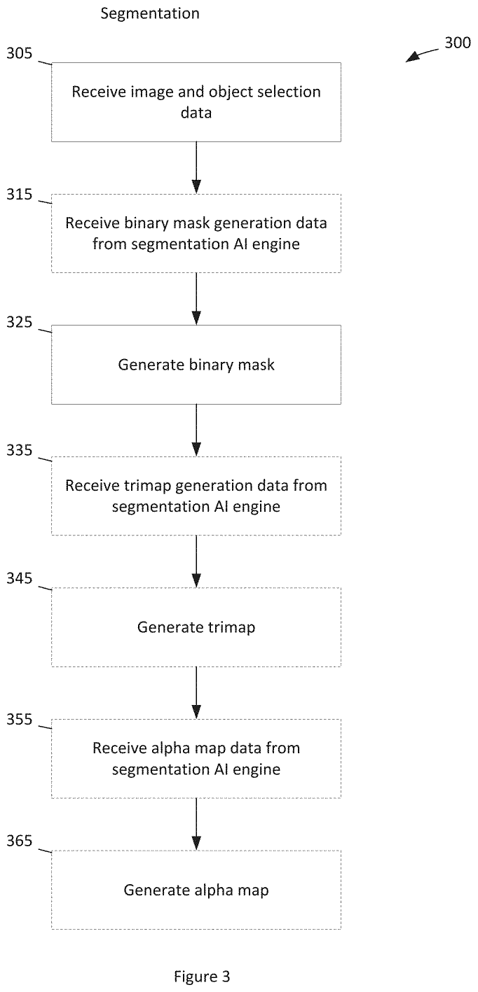

At 125, a matte is generated, for example, by the computer system. In the generated matte, each of the object selected at 115 are segmented as foreground objects, and the remainder of the image is segmented as background. The segmentation may be made in response to inputs provided by a user viewing a graphical interface displaying the image, where the inputs provide an indication of the object or objects to be segmented. In some embodiments, the object or objects or parts thereof are segmented automatically by the computer system. In some embodiments, one or more of the objects or parts thereof are segmented automatically, and an additional one or more objects or parts thereof are segmented in response to inputs provided by a user. In some embodiments, the automatic segmentation of one or more objects or parts thereof is performed using an artificial object segmentation intelligence system having object segmentation parameters which are modified based on differences between object boundaries determined by the object segmentation artificial intelligence system and object boundaries determined by a user for objects in images different from the image represented by the data received at 105. An embodiment of a method which can be used to segment the image is discussed below with reference to FIG. 3.

In some embodiments, 115 and 125 effectively occur as a single step. For example, in some embodiments, the computer system effectively selects the objects and generates a matte as a single step.

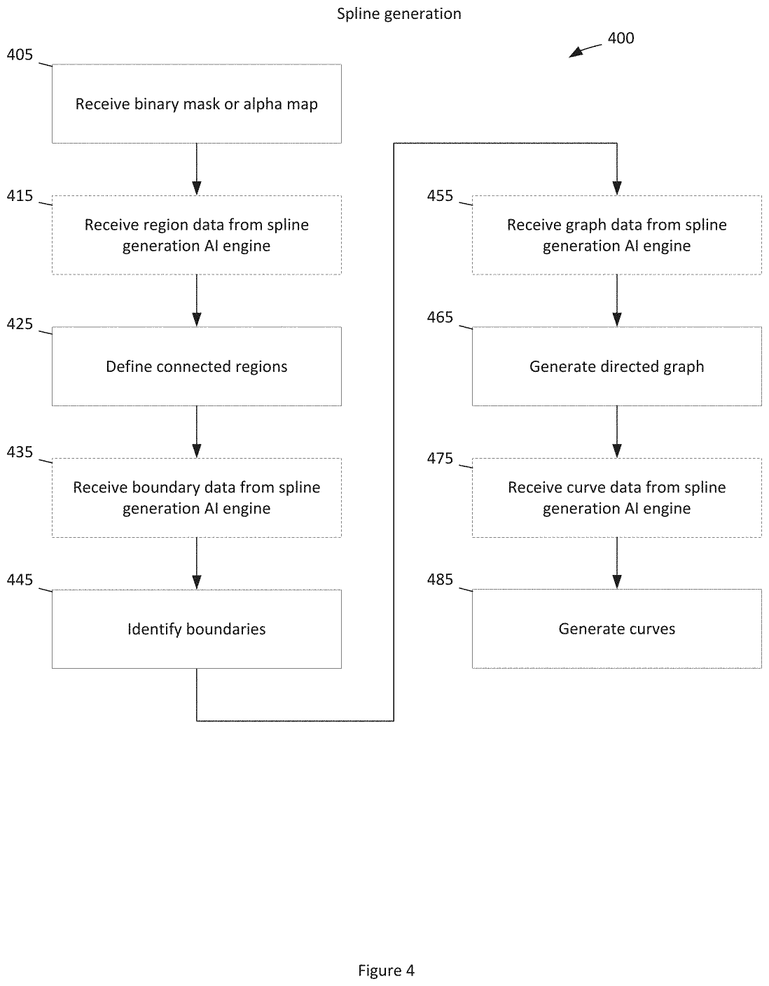

At 135, splines are generated, for example, by the computer system. The splines are positioned and shaped so as to define a boundary between the foreground objects and the background. The splines may be generated in response to inputs provided by a user viewing a graphical interface displaying the image and/or the matte, where the inputs provide an indication of the spline characteristics. In some embodiments, one or more of the splines are generated automatically by the computer system. In some embodiments, one or more of the splines are generated automatically, and an additional one or more splines are generated in response to inputs provided by a user. In some embodiments, the automatic spline generation of one or more splines is performed using a spline generation artificial intelligence system having spline generation parameters which are modified based on differences between object boundaries determined by the spline generation artificial intelligence system and object boundaries determined by a user for objects in images different from the image represented by the data received at 105. An embodiment of a method which can be used to generate the splines is discussed below with reference to FIG. 4.

When method 100 is used for a series of images representing a video, at optional 145, control points of the splines generated at 135 are tracked and adjusted, for example, by the computer system. For example, the control points of one or more of the splines may correspond with particular features or particular boundaries between features of the image. For example, in the image 10, a first spline control point may correspond with the top of the athletes head, a second spline control point may correspond with a transition between clothes of the athlete, and a third spline control point may correspond with a transition between clothes and skin of the athlete.

At 145, one or more corresponding control points of one or more previous images may be used to generate a characterization or description of the expected image location for the corresponding control point in the current image. For example, a control point of a previous image may be located at a particular pixel in the previous image, where the particular pixel is part of a continuous group of pixels defining a reference image. An area of the current image near the pixel of the corresponding control point as positioned at 135 may be searched to determine which continuous group of pixels of the current image best matches the reference image. Once the best matching continuous group of pixels of the current image is determined, the corresponding control point of the current image is moved to a particular pixel of the best matching continuous group of pixels, where the particular pixel corresponds with the pixel of the reference image corresponding with the control point of the previous image.

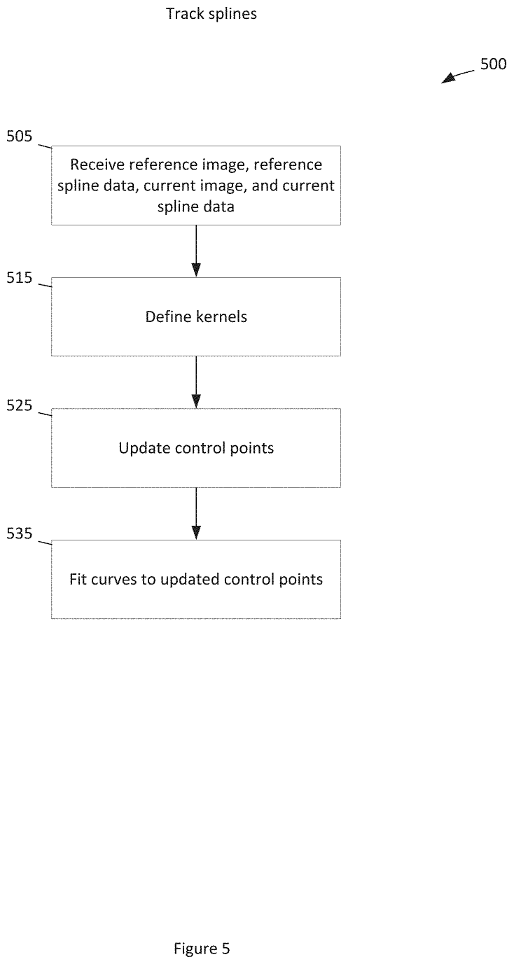

An embodiment of a method which can be used to track and adjust the control points is discussed below with reference to FIG. 5.

At 105, data representing an image is received At 115, one or more objects represented in the image are selected, At 125, a matte is generated, for At 135, splines are generated, for example, by the computer system. At 145, one or more corresponding control points of one or more previous images may be used to generate a characterization or description of the expected image location for the corresponding control point in the current image. At 155, the splines may be modified, for example, by the computer system in response to inputs provided by a user viewing a graphical interface displaying the image and the splines, where the inputs provide an indication of the location of the splines and locations of the control points of the splines. For example, if a connected set of splines bound multiple objects, the user may add and modify splines so that each of the objects is bounded by a set of splines.

Data representing the modifications to the splines may be stored in a memory of the computer system so that, for example, one or more of the object selection artificial intelligence system, the segmentation artificial intelligence system, and the spline generation artificial intelligence system may be further trained based on the modifications to the splines made at 155.

In some embodiments, at 165, the control points of the splines of the image may be again tracked and adjusted as discussed with reference to 145.

At 157, which one or more of the object selection artificial intelligence system, the segmentation artificial intelligence system, and the spline generation artificial intelligence system is to be trained based on the modifications to the splines made at 155 is determined, for example by the computer system. In some embodiments, which one or more of the object selection artificial intelligence system, the segmentation artificial intelligence system, and the spline generation artificial intelligence system is to be trained based on the modifications to the splines made at 155 is determined, for example, based on input from a user. In addition, based on the stored data representing the modifications to the splines made at 155, training data for the determined one or more of the object selection artificial intelligence system, the segmentation artificial intelligence system, and the spline generation artificial intelligence system is generated The training data may include, for example, the modified splines and/or a mask generated based on the modified splines.

At 112, the training data for the object selection artificial intelligence system is used to update or further train the object selection artificial intelligence system, for example, by the computer system. For example, the training data may be added to the training dataset which is used to train the object selection artificial intelligence system, using techniques understood by those of skill in the art.

At 122, the training data for the segmentation artificial intelligence system is used to update or further train the segmentation artificial intelligence system, for example, by the computer system. For example, the training data may be added to the training dataset which is used to train the segmentation artificial intelligence system, using techniques understood by those of skill in the art.

At 132, the training data for the spline generation artificial intelligence system is used to update or further train the spline generation artificial intelligence system, for example, by the computer system. For example, the training data may be added to the training dataset which is used to train the spline generation artificial intelligence system, using techniques understood by those of skill in the art.

In some embodiments, the matte generated by method 100 may be used to generate an output image, such as that shown in image 30 of FIG. 1. For example, in the output image, pixels of the objects of interest use color or grayscale information from the image data, and pixels of the background may use color or grayscale information input by a user or otherwise determined by the computing system. Any method known to those of skill in the art may be used to generate the output image.

In some embodiments, the color or grayscale information of the pixels of the objects of interest are superimposed on another background image, for example, as shown in image 40 of FIG. 1. In some embodiments, the splines of the objects of interest may also be illustrated in the image. Any method known to those of skill in the art may be used to produce the image.

FIG. 2 illustrates a flowchart diagram representing features of a method 200 of selecting objects according to some embodiments. The method 200 may be used as or part of 115 of method 100. Method 100 may use alternative methods of selecting objects. The method 200 may be performed using a computer system, such as that described with reference to FIG. 9. The method 200 may alternatively be performed using different computer systems.

At 215, inputs may be received from a user, for example, by a computer system. The user, for example, may view graphical interface of the computer system displaying the image. The inputs provide an indication of the object or objects represented in the image to be selected. For example, the inputs may provide an indication of one or more boundaries between the athlete illustrated in image 10 and the background of image 10. In some embodiments, the inputs may provide a bounding box encompassing one or more particular objects represented in the image and encompassing a portion of the background and/or one or more other objects represented in the image.

At 225, selection data from object selection artificial intelligence system may be received, for example, by the computer system. Furthermore, the object selection artificial intelligence system may also be operating in the computer system. The selection data from object selection artificial intelligence system may include boundary selection criteria, such as one or more of edge detection criteria, color or contrast criteria, feature detection criteria, and other criteria known to those of skill in the art, for example, of computer vision systems. In some embodiments, the selection data from object selection artificial intelligence system may additionally or alternatively include other data.

At 235, the objects are selected, for example, by the computer system. For example, the selection may be made in response to any inputs provided by the user at 215, and in response to any object selection data received at 225. In some embodiments, the object selection data is encoded, for example, in a file or other data structure, which communicates the positions of the boundaries of the selected objects.

For example, if the inputs from the user indicate one or more boundaries between an object and the background, those boundaries may be used as corresponding boundaries of the selected objects. At 235, the computer system may automatically generate additional boundaries of selected objects, as needed. For example, if the boundaries of the selected objects generated based on inputs from the user do not form a closed shape, the computer system may automatically generate additional boundaries so as to close the shape partially defined by the boundaries generated based on inputs from the user. The additional boundaries may be generated based on the selection data of the object selection artificial intelligence system.

In some embodiments, the computer system may automatically generate boundaries so as to generate closed shapes corresponding to each of one or more objects of the image. The boundaries may communicate or identify which object each pixel of the image is a part of. The generated boundaries may be generated based on the selection data of the object selection artificial intelligence system. For example, in some embodiments, the boundaries are automatically generated using one or more of a semantic segmentation method and another object identification method known to those of skill in the art.

FIG. 3 illustrates a flowchart diagram representing features of a method 300 of segmenting an image according to some embodiments. The method 300 may be used as or part of 125 of method 100. Method 100 may use alternative methods of segmentation.

The method 300 receives image data and object selection data and generates a matte file which communicates the locations of the selected objects. In the matte, selected objects are segmented as foreground objects, and the remainder of the image is segmented as background. The matte file may, for example, be a binary mask or an alpha map. Other matte types may additionally or alternatively be generated. The method 300 may be performed using a computer system, such as that described with reference to FIG. 9. The method 300 may alternatively be performed using different computer systems.

At 305, image data representing an image is received, for example, by the computer system. The image data may be similar or identical to the data received using a process similar or identical to that of 105 of method 100. In some embodiments, the received image data is generated based on the data received by the process. Furthermore, at 305, object selection data representing positions of the boundaries of selected objects in the image of the image data is received. The object selection data may be similar or identical to data generated using a process similar or identical to that of 235 of method 200. In some embodiments, the received object selection data is generated based on the object selection data generated by the process.

In some embodiments, at 315, binary mask generation parameter data is received, for example, by the computer system from the object segmentation artificial intelligence system. The binary mask generation parameter data provides information, and in some embodiments, rules which describe distinctions between selected objects and background, and describe distinctions between different selected objects.

At 325, a binary mask is generated, for example, by a binary mask generation module running on the computer system. For example, based on the image data and the object selection data, the computer system may generate a binary mask, for example, using semantic segmentation, such as iterative user refined segmentation, and/or other techniques. Any binary mask generation process known in the art may be used.

In some embodiments, at 325, the binary mask is generated based additionally on the binary mask generation parameter data received from the object segmentation artificial intelligence system at 315.

In some embodiments, the matte generated by method 300 comprises or is the binary mask.

In some embodiments, at 335, trimap generation parameter data is received, for example, by the computer system from the object segmentation artificial intelligence system. The trimap generation parameter data provides information, and in some embodiments, rules which describe distinctions between selected objects and background, and describe distinctions between different selected objects.

In some embodiments, at 345, a trimap is generated, for example, by a trimap generation module running on the computer system. For example, based on the image data and the binary mask, the computer system may generate a trimap, for example, using morphological transformations to define edges. In some embodiments, other AI detection techniques may be used, for example, to find special regions like hair. Any trimap generation process known in the art may be used. In some embodiments, the trimap is generated based additionally on the object selection data.

In some embodiments, at 345, the trimap is generated based additionally on the trimap generation parameter data received from the object segmentation artificial intelligence system at 335.

In some embodiments, at 355, alpha map generation parameter data is received, for example, by the computer system from the object segmentation artificial intelligence system. The alpha map generation parameter data provides information, and in some embodiments, rules which describe distinctions between selected objects and background, and describe distinctions between different selected objects.

In some embodiments, at 365, an alpha map is generated, for example, by an alpha map generation module running on the computer system. For example, based on the image data and the trimap, the computer system may generate an alpha map, for example, using alpha matting and or other known techniques. Any alpha map generation process known in the art may be used. In some embodiments, the alpha map is generated based additionally on the binary mask. In some embodiments, the alpha map is generated based additionally on the object selection data.

In some embodiments, at 365, the alpha map is generated based additionally on the alpha map generation parameter data received from the object segmentation artificial intelligence system at 355.

In some embodiments, the matte generated by method 300 comprises or is the trimap.

FIG. 4 illustrates a flowchart diagram representing features of a method 400 of generating splines for an image according to some embodiments. The method 400 may be used as or part of 135 of method 100. Method 100 may use alternative methods of generating splines.

The method 400 receives a matte and generates splines which correspond with boundaries of the foreground objects of the matte. The method 400 may be performed using a computer system, such as that described with reference to FIG. 9. The method 400 may alternatively be performed using different computer systems.

At 405, matte data is received, for example, by the computer system. The matte data may be similar or identical to the matte generated using a process similar or identical to that of method 300. In some embodiments, the matte data is generated based on the matte generated by the process.

In some embodiments, at 415, region parameter data is received, for example, by the computer system from the spline generation artificial intelligence system. The region parameter data provides information, and in some embodiments, rules which describe distinctions between selected objects and background in the matte data, and describe distinctions between different selected objects in the matte data.

At 425, connected regions are defined, for example, by a connected region definition module running on the computer system. For example, based on the matte data, the computer system may define connected regions. In some embodiments, an 8-pixel connectivity test is used to define the regions. Using this method, 8 connected pixels are arranged in a square. Connected pixels are those that touch one of the edges or corners of the 8 connected pixels. These pixels are connected horizontally, vertically, and diagonally. For example, each pixel with coordinates (x±1, y±1), p1 to p8, is connected to the pixel at (x,y). Other processes may be used to define connected regions. Any process known in the art for defining connected regions may be used. As a result, each object can be detected in a separate region, except when they overlap in the image. In this case a region may contain more than one object.

In some embodiments, at 425, the connected regions are defined based additionally on the region parameter data received from the spline generation artificial intelligence system at 415.

In some embodiments, at 435, boundary parameter data is received, for example, by the computer system from the spline generation artificial intelligence system. The boundary parameter data provides information, and in some embodiments, rules which describe distinctions between selected objects and background, and describe distinctions between different selected objects.

In some embodiments, at 445, boundaries are identified, for example, by a boundary identification module running on the computer system. In some embodiments, a particular pixel is identified as a boundary pixel if the particular pixel is part of a foreground object and has at least one neighboring pixel in the background. This may be determined, for example, using a 4-pixel connectivity method. In some embodiments, pixels are identified as being connected or not connected to the foreground object or to the background. The boundaries are defined as sets of connected boundary pixels.

In some embodiments, based on the connected regions defined at 425, the computer system may identify boundaries. Any boundary identification process known in the art may be used. In some embodiments, the boundaries are identified based additionally on the matte.

In some embodiments, at 445, the boundaries are identified based additionally on the boundary parameter data received from the spline generation artificial intelligence system at 435.

In some embodiments, at 455, graph generation parameter data is received, for example, by the computer system from the spline generation artificial intelligence system. The graph generation parameter data provides information, and in some embodiments, rules which describe distinctions between portions of selected objects.

In some embodiments, at 465, a directed graph for each object is generated, for example, by a directed graph generation module running on the computer system. For example, each directed graph may start with a particular identified boundary pixel, following one direction around an object without loops and end with the particular identified boundary pixel. In some embodiments, based on the boundaries identified at 445, the computer system may generate the directed graphs, for example, using a technique that recursively walks the boundary of the object using neighboring pixels. Any directed graph generation process known in the art may be used. In some embodiments, the directed graphs are generated based additionally on the connected regions defined at 425. In some embodiments, the directed graphs are generated based additionally on the matte.

In some embodiments, at 465, the directed graphs are generated based additionally on the graph generation parameter data received from the spline generation artificial intelligence system at 455.

In some embodiments, at 475, curve generation parameter data is received, for example, by the computer system from the spline generation artificial intelligence system. The curve generation parameter data provides information, and in some embodiments, rules which describe perimeters of selected objects.

In some embodiments, at 485, curves are generated, for example, by a curve generation module running on the computer system. In some embodiments, the curves are Bezier curves. In some embodiments, the directed graph points define a path around each object, and curves are iteratively fit to the paths based on a maximum cumulative error between each curve and its corresponding path. If the error is greater than the maximum error threshold, then the curve is split in two parts (half point) and the process is repeated.

In some embodiments, based on the directed graph generated at 465, the computer system may generate curves, for example, using a curve fitting technique, for example, using numerical methods. Any curve generation process known in the art may be used. In some embodiments, the curves are generated based additionally on the boundaries identified at 445. In some embodiments, the curves are generated based additionally on the connected regions defined at 425. In some embodiments, the curves are generated based additionally on the matte.

In some embodiments, at 485, the curves are generated based additionally on the curve generation parameter data received from the spline generation artificial intelligence system at 475.

FIG. 5 illustrates a flowchart diagram representing features of a method 500 of tracking spline control points from one or more previous images to a current image, where the previous and current images may, for example, be part of a video. The method 500 may be used as or part of 145 and/or 165 of method 100. Method 100 may use alternative methods of tracking spline points.

The method 500 uses locations for spline control points from a reference frame to determine or modify locations of corresponding spline control points in a current frame. The method 500 may be performed using a computer system, such as that described with reference to FIG. 9. The method 500 may alternatively be performed using different computer systems.

At 505, a reference image and reference spline control point location information is received, for example, by a computer system. The reference spline control point location information identifies locations for one or more reference spline control points. The locations of the reference spline control points may have been determined based on one or more previous images. At 505, a current image and current spline control point location information is received, for example, by the computer system. The current spline control point location information identifies locations for one or more current spline control points. The locations of the current spline control points may have been determined using a process such as that described with reference to 105-135 of method 100.

At 515, a kernel (or mask region) is defined for each reference control point, for example, by the computer system. Each kernel may have a center point at its corresponding reference control point. In some embodiments, each kernel defines a circle or substantially a circle having a radius. In some embodiments, each kernel defines a square or another shape of pixels. The kernel for each reference control point includes the color information of the pixels therein.

At 525, the current control point locations are modified, for example, by the computer system. For example, for a particular reference control point, the computer system identifies the kernel associated therewith and identifies the particular current control point corresponding with the particular reference control point.

The computer system searches a search area near the particular current control point for a group of pixels which best match the kernel of the corresponding particular reference control point. In some embodiments, the area searched may be larger than the area of the kernel of the corresponding particular reference control point. For example, the area searched may be about 10, about 12, about 14, about 16, about 18, about 20, about 24, about 28, or about 32 times larger than the area of the kernel of the corresponding particular reference point. In some embodiments, the area searched may have the same or substantially the same shape as the kernel of the corresponding particular reference point.

In some embodiments, a convolution algorithm is used to determine which group of pixels of the current image best matches the kernel. For example, for each pixel of the search area, a test area is defined having the same shape and size as the kernel, and the color information of the test area is convolved with the kernel to determine a test score for the test area. Accordingly, a test score is generated for each pixel of the search area. In some embodiments, the test score represents a square error. The test scores may be compared to determine which test area best matches the kernel. After the best matching test area is identified, the corresponding particular current control point is moved to the particular pixel of the identified test area.

Alternatively, for each particular pixel of the search area a test group of connected pixels may be defined where the test group is defined as the perimeter pixels of a test area having the same size and shape as the kernel, where the perimeter pixels of the test area have the same special relationship with the particular pixel of the search area as the perimeter pixels of the kernel have with the corresponding particular pixel of the reference image. The color information of the test group is convolved with the perimeter pixels of the kernel to determine a test score for the test group. Accordingly, a test score is generated for each pixel of the search area. In some embodiments, the test score represents a square error. The test scores may be compared to determine which test group best matches the kernel. After the best matching test group is identified, the corresponding particular current control point is moved to the particular pixel of the identified test group.

In some embodiments, alternative methods of determining locations for updating the current control points may be used.

At 535, boundary control points on the object boundaries are used to generate curves connecting the boundary control points. Any curve fitting algorithm may be used.

FIG. 6 illustrates a flowchart diagram representing features of a method 600 of generating mattes for video images according to some embodiments. The method may be performed using a computer system, such as that described with reference to FIG. 9. The method may alternatively be performed using different computer systems.

At 605, data representing an image (frame) of the video is received. For example, data representing the illustrated image 10 may be received, for example, at a processor. In some embodiments, the received data represents a color image.

At 615, reference matte data is received, for example, by the computer system. The reference matte data may be generated using a process similar or identical to that of method 300 to create a reference matte based on one or more previous frames of the video. The reference matte data may have been generated in an earlier occurrence of 625, discussed below, and stored in an earlier occurrence of 635, discussed below. In some embodiments, the reference matte data comprises a binary mask or alpha map data.

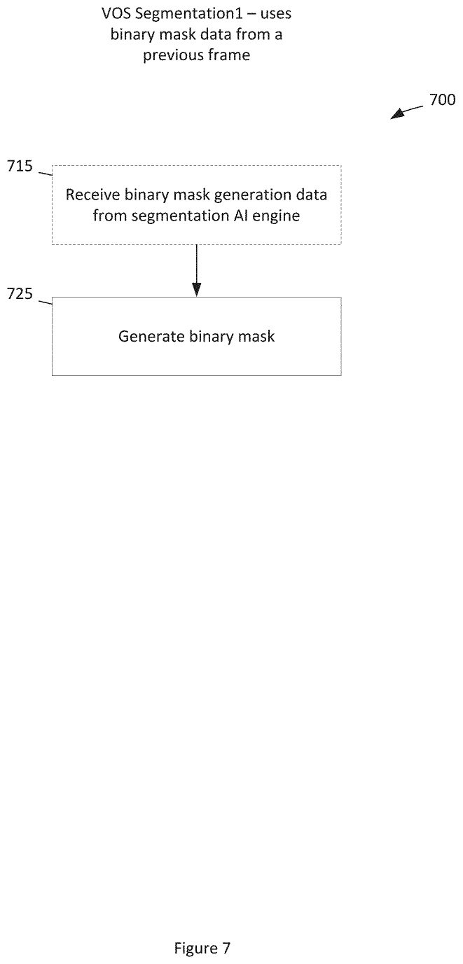

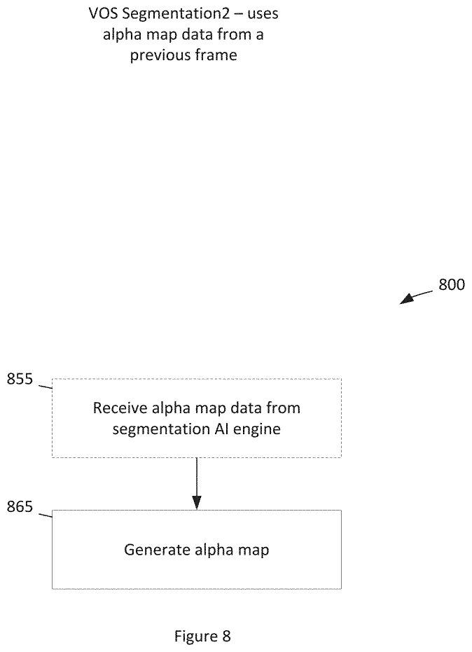

At 625, a current matte is generated for the current frame, for example, by the computer system. In the generated current matte, objects are segmented as foreground objects corresponding with objects in the reference matte data, and the remainder of the image is segmented as background. The segmentation may be made in response to inputs provided by a user viewing a graphical interface displaying the image, where the inputs provide an indication of the object or objects to be segmented. In some embodiments, the object or objects or parts thereof are segmented automatically by the computer system. In some embodiments, one or more of the objects or parts thereof are segmented automatically, and an additional one or more objects or parts thereof are segmented in response to inputs provided by a user. In some embodiments, the automatic segmentation of one or more objects or parts thereof is performed using an artificial object segmentation intelligence system having object segmentation parameters which are modified based on differences between object boundaries determined by the object segmentation artificial intelligence system and object boundaries determined by a user for objects in images different from the image represented by the data received at 605. An embodiment of methods which can be used to segment the image are discussed below with reference to FIGS. 7 and 8.

At 635, the current matte generated at 625 is stored in a memory, so that, for example, at a subsequent occurrence of 615, the current matte generated at 625 can be received by the computer system for use in generating a future matte at a future occurrence of 625.

At 645, splines are generated, for example, by the computer system using a process similar or identical to the process of method 100 at 135.

At 655, one or more corresponding control points are tracked, for example, by the computer system using a process similar or identical to the process of method 100 at 145.

At 665, the splines may be modified, for example, by the computer system using a process similar or identical to the process of method 100 at 155.

In some embodiments, at 665, the control points of the splines of the image may be again tracked and adjusted as discussed with reference to 645.

At 667, training data for one or more of the segmentation artificial intelligence system, and the spline generation artificial intelligence system is generated, for example, by the computer system using a process similar or identical to the process of method 100 at 157.

At 622, the training data for the segmentation artificial intelligence system is used to update or further train the segmentation artificial intelligence system, for example, by the computer system using a process similar or identical to the process of method 100 at 122.

At 642, the training data for the spline generation artificial intelligence system is used to update or further train the spline generation artificial intelligence system, for example, by the computer system using a process similar or identical to the process of method 100 at 132.

In some embodiments, the matte generated by method 600 may be used to generate an output image, such as that shown in image 30 of FIG. 1. For example, in the output image, pixels of the objects of interest use color or grayscale information from the image data, and pixels of the background may use color or grayscale information input by a user or otherwise determined by the computing system. Any method known to those of skill in the art may be used to generate the output image.

In some embodiments, the color or grayscale information of the pixels of the objects of interest are superimposed on another background image, for example, as shown in image 40 of FIG. 1. In some embodiments, the splines of the objects of interest may also be illustrated in the image. Any method known to those of skill in the art may be used to produce the image.

FIG. 7 illustrates a flowchart diagram representing features of a method 700 of segmenting an image according to some embodiments. The method 700 may be used as or part of 625 of method 600. Method 600 may use alternative methods of segmentation.

The method 700 receives current frame data and a reference binary mask, and generates a current binary mask which communicates the locations of foreground objects of the current frame. In the current binary mask, foreground objects of the current frame data corresponding with foreground objects of the reference binary mask are identified and segmented as foreground objects, and the remainder of the current frame is segmented as background. The method 700 may be performed using a computer system, such as that described with reference to FIG. 9. The method 700 may alternatively be performed using different computer systems.

In some embodiments, at 715, binary mask generation parameter data is received, for example, by the computer system from an object segmentation artificial intelligence system. The binary mask generation parameter data provides information, and in some embodiments, rules which describe distinctions between selected objects and background, and describe distinctions between different selected objects.

At 725, a current binary mask is generated for the current frame, for example, by a binary mask generation module running on the computer system. For example, based on the current frame data and the reference binary mask, the computer system may generate a current binary mask for the current frame data. The current binary mask generation may be done, for example, using semantic segmentation, iterative user refined segmentation and/or other techniques. Any binary mask generation process known in the art may be used.

In some embodiments, at 725, the binary mask is generated based additionally on the binary mask generation parameter data received from the object segmentation artificial intelligence system at 715.

FIG. 8 illustrates a flowchart diagram representing features of a method 800 of segmenting an image according to some embodiments. The method 800 may be used as or part of 625 of method 600. Method 600 may use alternative methods of segmentation.

The method 800 receives current frame data and a reference alpha map, and generates a current alpha map which communicates the locations of foreground objects of the current frame. In the current alpha map, foreground objects of the current frame data corresponding with foreground objects of the reference alpha map are identified and segmented as foreground objects, and the remainder of the current alpha map segmented as background. The method 800 may be performed using a computer system, such as that described with reference to FIG. 9. The method 800 may alternatively be performed using different computer systems.

In some embodiments, at 855, alpha map generation parameter data is received, for example, by the computer system from an object segmentation artificial intelligence system. The alpha map generation parameter data provides information, and in some embodiments, rules which describe distinctions between selected objects and background, and describe distinctions between different selected objects.

At 865, a current alpha map is generated for the current frame, for example, by an alpha map generation module running on the computer system. For example, based on the current frame data and the reference alpha map, the computer system may generate a current alpha map for the current frame data. The current alpha map generation may be done, for example, using alpha matting and or other known techniques. Any alpha map generation process known in the art may be used.

In some embodiments, at 865, the alpha map is generated based additionally on the alpha map generation parameter data received from the object segmentation artificial intelligence system at 855.

As understood by those of skill in the art, processes receiving or generating a binary mask may be replaced with corresponding processes receiving or generating an alpha map. Similarly, as understood by those of skill in the art, processes receiving or generating an alpha map may be replaced with corresponding processes receiving or generating a binary mask.

FIG. 9 illustrates a computer system which may be used to perform aspects of the methods according to some embodiments. Processes of the kind described herein can be implemented using computer systems of generally conventional design, programmed to carry out operations of processes such as process 100, 200, 300, 400, 500, 600 and/or process 800 described above. FIG. 9 is a simplified block diagram of a computer system 900 configured to implement process 100, 200, 300, 400, 500, 600 and/or process 800 described above. In this embodiment, computer system 900 includes processing subsystem 902, storage subsystem 904, user interface 906, and network interface 908.

Processing subsystem 902 can include one or more general purpose programmable processors capable of executing program code instructions to perform various operations, including operations described herein. In some embodiments, processing subsystem 902 may incorporate scalable processing hardware (e.g., an array of server blades or the like) that can be adapted dynamically to varying processing needs.

Storage subsystem 904 can include a combination of volatile and nonvolatile storage elements (e.g., DRAM, SRAM, flash memory, magnetic disk, optical disk, etc.). Processing module instructions 910 of storage subsystem 904 may be used to store program code to be executed by processing subsystem 902. Examples of program code can include code, which, when executed causes computer system 900 to implement the processing modules discussed above, and can include code, which, when executed causes computer system 900 to implement any of methods 100, 200, 300, 400, 500, 600 and/or process 800 described above. The program code can include code, which, when executed causes computer system 900 to implement the artificial intelligence systems discussed above. Portions of storage subsystem 904 may also be used to store data files 920, including video files, image data, segmentation data, spline data, training data for the artificial intelligence systems, and data representing the trained state of the artificial intelligence systems.

User interface 906 can include user input devices and/or user output devices. Examples of user input devices include a keyboard, mouse, joystick, touch pad, touch screen, microphone, and so on. Examples of user output devices include a display device (which may be touch-sensitive), speakers, indicator lights, a printer, and so on. In some embodiments, user interface 906 is remotely located from one or both of processing subsystem 902 and storage subsystem 904. For example, one or both of processing subsystem 902 and storage subsystem 904 may be located at a cloud computing facility connected with user interface 906 by a network.

Network interface 908 can be implemented using any combination of hardware and software components that together enable communication with other computer systems. In some embodiments, network interface 908 may communicate with a local area network (LAN) using Ethernet, Wi-Fi, or other similar technologies, and the LAN may enable communication with a wide area network (WAN) such as the internet. Via network interface 908, computer system 900 can communicate with one or more other computer systems to support distributed implementations of processes described herein.

In some embodiments, computer system 900 may operate in a server configuration, communicating with one or more client computers via network interface 908. For example, computer system 900 may operate compression module 910 to generate compressed data, then transmit the compressed data to one or more client computers via network interface 908. In embodiments where computer system 900 is operated remotely via network interface 908, local user interface 906 may be limited (e.g., just a few indicator lights) or omitted entirely.

It will be appreciated that computer system 900 is illustrative and that variations and modifications are possible. For instance, although computer system 900 and its operations are described herein with reference to particular blocks, it is to be understood that these blocks are defined for convenience of description and are not intended to imply a particular physical arrangement of component parts or a particular software architecture. Further, the blocks need not correspond to physically distinct components. Blocks can be configured to perform various operations, e.g., by programming a processor or providing appropriate control circuitry, and various blocks might or might not be reconfigurable depending on how the initial configuration is obtained. Embodiments of the present invention can be realized in a variety of apparatus including computing devices and computer systems implemented using any combination of circuitry and software.

Computer programs incorporating various features of the present invention may be encoded and stored on various computer readable storage media; suitable media include magnetic disk or tape, optical storage media such as compact disk (CD) or DVD (digital versatile disk), flash memory, and other non-transitory media. (It is understood that “storage,” and the like of data is distinct from propagation of data using transitory media such as carrier waves.) Computer readable media encoded with the program code may be packaged with a compatible computer system or other electronic device, or the program code may be provided separately from electronic devices (e.g., as a separately packaged computer readable storage medium or via an internet download process that results in the program code being stored on a computer-readable storage medium of the electronic device that downloads it).

In alternative embodiments, a purpose built processor may be used to perform some or all of the operations described herein. Such processors may be optimized, e.g., for performing specific operations described herein, such as video compression.

While the invention has been described with reference to specific embodiments, those skilled in the art with access to the present disclosure will recognize that variations and modifications are possible. Processing operations described sequentially can be performed in parallel, order of operations can be modified, and operations can be combined or omitted. Further, operations not specifically described herein may be added. The particular algorithms for segmenting a sequence of 3D video frames, identifying consistent mesh sequences, compressing texture data, and/or compressing consistent mesh sequence data described above are illustrative, and other algorithms may be substituted.

As noted above, a frame may contain one or more meshes, and each mesh may be compressed in the manner described herein. All texture maps associated with a mesh in a given frame can be combined in a single CTA. In some embodiments where a frame contains multiple meshes, a topological change in any one mesh may result in defining a segment boundary. Other implementations are possible.

Thus, although the invention has been described with respect to specific embodiments, it will be appreciated that the invention is intended to cover all modifications and equivalents within the scope of the following claims.

What is claimed is:

1. A method of generating a matte for an image, the method comprising:
with a processor, receiving image data representing the image;
with the processor, selecting one or more objects represented in the image data;
with the processor, generating an intermediate matte based on the selected objects;
with the processor, generating one or more splines based on the intermediate matte,
wherein at least one of the selecting of the one or more objects, the generating of the intermediate matte, and the generating of the splines is performed by an artificial intelligence system;
with the processor, receiving instructions to modify the generated splines;
with the processor, generating modified splines by modifying the generated splines according to the received instructions;
with the processor, generating training data based on the modified splines; and
with the processor, training the artificial intelligence system with the training data.

2. The method of claim 1, wherein the image is one of a series of video images.

3. The method of claim 1, wherein the one or more objects are selected based at least in part on one or more inputs from a user.

4. The method of claim 1, wherein the one or more objects are selected automatically by the processor.

5. The method of claim 1, wherein the intermediate matte is generated based at least in part on one or more inputs from a user.

6. The method of claim 1, wherein the intermediate matte is generated automatically by the processor.

7. The method of claim 1, wherein the one or more splines are generated based at least in part on one or more inputs from a user.

8. The method of claim 1, wherein the one or more splines are generated automatically by the processor.

9. The method of claim 1, wherein the one or more splines each comprise a plurality of control points, and wherein the method further comprises:
with the processor, receiving data representing a reference image; and
with the processor, modifying a position of a particular control point based on the reference image.

10. The method of claim 9, wherein the position of the particular control point is modified before the instructions to modify the generated splines are received.

11. The method of claim 10, wherein the position of the particular control point is additionally modified after the instructions to modify the generated splines are received.

12. A method of generating a matte for each image of a series of video images, the method comprising:
with a processor, receiving data for a first image of the series of video images;
with the processor, receiving data for a reference matte;
with the processor, generating an intermediate matte based on the data for the first image and the data for the reference matte;
with the processor, generating the intermediate matte;
with the processor, generating one or more splines based on the intermediate matte,
wherein at least one of the generating of the intermediate matte, and the generating of the one or more splines is performed by an artificial intelligence system;
with the processor, receiving instructions to modify the generated splines;
with the processor, generating modified splines by modifying the generated splines according to the received instructions;
with the processor, generating training data based on the modified splines; and
with the processor, training the artificial intelligence system with the training data.

13. The method of claim 12, further comprising generating the data for the reference matte based on another intermediate matte generated for a second image of the series of video images.

14. The method of claim 12, wherein the intermediate matte is generated based at least in part on one or more inputs from a user.

15. The method of claim 12, wherein the intermediate matte is generated automatically by the processor.

16. The method of claim 12, wherein the one or more splines are generated based at least in part on one or more inputs from a user.

17. The method of claim 12, wherein the one or more splines are generated automatically by the processor.

18. The method of claim 12, wherein the one or more splines each comprise a plurality of control points, and wherein the method further comprises:
with the processor, receiving data representing a reference image; and
with the processor, modifying a position of a particular control point based on the reference image.

19. The method of claim 18, wherein the position of the particular control point is modified before the instructions to modify the generated splines are received.

20. The method of claim 19, wherein the position of the particular control point is additionally modified after the instructions to modify the generated splines are received.
